(19) United States
(12) Patent Application Publication
(10) Pub. No.: US 2002/0103581 A1
(43) Pub. Date: Aug. 1, 2002

(54) Testing method for determining the rollover resistance of a vehicle

(75) Inventor: Edmund Donges, Fuerstenfeldbruck (DE)

Correspondence Address: Crowell & Moring, L.L.P., P.O. Box 14300, Washington, DC, 20044-4300, US

(73) Assignee: Bayerische Motoren Werke AG

(21) Appl. No.: 10/056,008

(22) Filed: Jan. 28, 2002

(30) Foreign Application Priority Data
Jan. 26, 2001 (DE) 10103414.8

(51) Int. Cl. G01M 17/00; G06F 7/00

(52) U.S. Cl. 701/29

(57) ABSTRACT

A testing method determines the rollover resistance of a vehicle. In a first step, the intrinsic rolling frequency of the vehicle is determined and, in a second step, the vehicle is excited by a steering frequency which corresponds to one third of the intrinsic rolling frequency. At least temporarily, a range of the maximal frictional connection potential is reached at least approximately.

### BACKGROUND OF THE INVENTION

This application claims the priority of Germany 10103414.8 filed Jan. 26, 2001 the disclosure of which is expressly incorporated by reference herein.

The present invention relates to a testing method for determining the rollover resistance of a vehicle on a flat road.

Especially in recent times, the public's attention has increasingly been drawn to the rollover resistance of motor vehicles. This attention was, on one hand, generated by actual vehicle tests which indicate weaknesses with respect to the rollover resistance of individual models. On the other hand, significant numbers of rollover accidents among the overall accident figures have created interest in the public, particularly in this country.

A number of improvement measures have been taken for increasing the rollover resistance of vehicles. Reference is made in this context to DE 196 15 737 A1, DE 196 54 223 A1, and DE 198 29 361 A1. Particularly in the latter publication, it was described that, when rolling motions occur which contain spectral fractions in the range of the intrinsic rolling frequency, a critical range may be reached with respect to the vehicle safety.

### SUMMARY OF THE INVENTION

In the present invention, no direct measure is introduced for increasing the rollover safety of a vehicle, but a testing method for determining the rollover resistance of a vehicle in a comprehensible and reproducible manner is provided.

An object of the present invention is to indicate a reproducible testing method which permits clear information concerning the rollover resistance of a tested vehicle to be obtained.

DE 198 29 361 A1 describes that a significant rollover risk has to be assumed when transient lateral movements of the vehicle, as can be initiated, for example, by steering movements at the steering wheel, contain spectral fractions which coincide with the intrinsic rolling frequency of the vehicle. It can be demonstrated in tests that, mainly because of the non-linear saturation characteristics of the lateral-force slip angle curve in the cross-dynamic vehicle reaction, a third harmonic wave occurs with respect to the steering movement, which is in the range of the intrinsic rolling frequency causing a particular rollover risk. It is naturally a prerequisite for a rollover risk that the maximal fictional connection potential between the tire and the road is largely utilized.

Based on this recognition, the present invention first determines the intrinsic rolling frequency of the vehicle and, in a second step, excites the vehicle by way of a steering frequency which corresponds to a third of the intrinsic rolling frequency. In this case, one should at least partially be in the range of the maximal frictional connection potential. During a skidding or sliding of the vehicle on the driving surface, the rollover risk will be considerably reduced again.

The determination of the intrinsic rolling frequency can take place, for example, by measuring the rolling movement which is triggered by a harmonic rolling excitation with a continuously increasing frequency (i.e., sweeping through). Typical rolling excitations are in the range of from 0.5 to 4 Hz.

The excitation can be generated, for example, by a hydropulse system in which the left and right vehicle wheels respectively are lifted and lowered by a stroke movement in antiphase (or counterphase).

As an alternative, the intrinsic rolling frequency may also be determined by measuring the cross-dynamic vehicle behavior in the form of frequency response functions, in which case the vehicle reactions to frequency-swept harmonic or stochastic steering defaults are determined.

The intrinsic rolling frequency is in each case obtained from the frequency response of the amplitude of the rolling motion for the excitation at the frequency point at which the resonance step-up of the frequency response of the amplitude reaches a maximum.

As the testing methods for the rollover resistance, so-called “closed-loop” or “open-loop” testing methods may be used.

In a “closed-loop” testing method, for example, a wedeling or brushing lane can be marked by pylons. The spacing of the pylons is selected such that, in the case of a defined driving speed, a steering frequency is reached when moving through the wedeling lane, which steering frequency is situated in the range of a third of the intrinsic rolling frequency. When moving through the wedeling lane, a maximal rise of the amplifications of the vehicle will then be achieved. If all four or at least three wheels of the vehicle maintain the ground contact on a dry, non-skid road while the frictional connection potential is largely utilized, the rollover resistance of the vehicle is ensured. In order to achieve an extensive utilization of the frictional connection potential and thus utilize the saturation characteristic of the lateral-force slip angle curve, the pylons may optionally be laterally offset with respect to one another.

In an “open-loop” testing method, a steering frequency can be defined by a third of the intrinsic rolling frequency, for example, by a steering mechanism or a driver. In this case, the amplitude of the steering movement is continuously increased until the frictional connection potential is completely exhausted. Also [in this case], the rollover resistance of the vehicle is considered to be ensured when, at the maximally exhausted frictional connection potential, the ground contact of all four wheels or at least three wheels is maintained.

### BRIEF DESCRIPTION OF THE DRAWINGS

Other objects, advantages and novel features of the present invention will become apparent from the following detailed description of the invention when considered in conjunction with the accompanying drawings.

FIG. 1 is a schematic elevational end view of a vehicle on a hydropulse system; and

FIG. 2 is a schematic top view of a wedeling or sweeping lane driven by a vehicle.

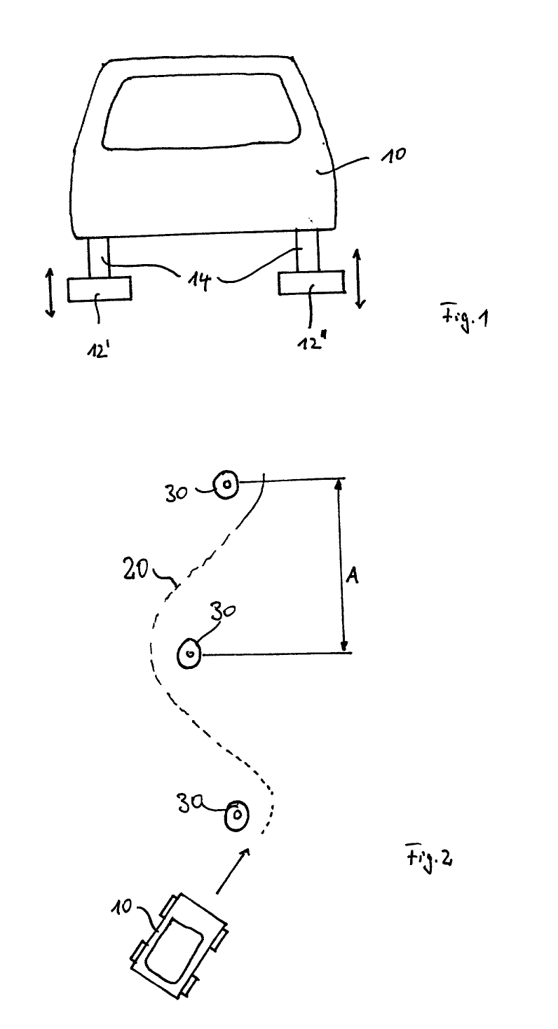

### DETAILED DESCRIPTION OF THE DRAWINGS

In the following, a simple “closed-loop” testing method according to the present invention will be described. In a first step, the intrinsic rolling frequency of a vehicle is determined. For this purpose, the vehicle is placed on a hydropulse system (indicated only schematically in this case), in which the left vehicle wheels is standing on the lifting piston 12′ and the right vehicle wheels is standing on the lifting piston 12″. As a result of an anti (or counter) phase moving up and down of the lifting pistons 12′, 12′ (double arrows), the right and left vehicle wheels respectively are also lifted and lowered in opposite directions. When a driving (sweeping) through the frequency for the rolling excitation of from 0.5 to 4 Hz now takes place, a maximal rolling amplitude is determined at an intrinsic frequency of the vehicle. The pertaining excitation frequency is defined as the intrinsic rolling frequency. The maximal rolling amplitude can easily be determined visually. If more precise measuring results are required, the maximal rolling amplitude can be determined, for example, also by the deflection of a gauging rod fastened on the vehicle.

For the second step of the testing method, a wedeling lane with pylons 30 is set up, specifically so that the spacing A of two pylons 30 arranged behind one another is selected such with respect to one another that, at a defined drive-through speed, for example, 50 km/h, a steering frequency of one third of the intrinsic rolling frequency must be implemented in order to correctly drive through the wedeling lane.

After the setting-up of the wedeling lane, the vehicle 10 must drive through it in a defined manner. If, in that case, all four or at least three wheels remain on the ground and a maximal lateral acceleration is reached, a rollover resistance of the vehicle can be assumed. In order to reach the corresponding lateral acceleration, all second pylons may be laterally offset with respect to the other pylons.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Testing method for determining rollover stability of a vehicle, comprising
determining the intrinsic rolling frequency of the vehicle, and
exciting the vehicle by a steering frequency which corresponds to a third of the intrinsic rolling frequency to reach at least temporarily a range of at least approximate maximal frictional connection potential.

2. Testing method according to claim 1,
wherein determining of the intrinsic rolling frequency is effected by acting upon the vehicle with an increased harmonic rolling excitation.

3. Testing method according to claim 2,
the exciting is carried out by a hydropulse system, in which at least one wheel of one vehicle side is alternately lifted and lowered in one direction and at least one wheel of the other vehicle side is lowered and lifted in an opposite direction.

4. Testing method according to claim 1,
wherein, for the exciting, a wedeling lane is used which has spaced pylons, and at a defined driving speed, the steering frequency corresponds to approximately a third of the intrinsic rolling frequency.

5. Testing method according to claim 4,
wherein the pylons are laterally offset such that a saturation characteristic of a lateral-force slip angle curve of the vehicle is reached.

6. Testing method according to claim 1,
wherein a steering frequency of approximately one third of the intrinsic rolling frequency is defined, and steering movement amplitude is increased.

7. Testing method according to claim 6,
wherein an increase of the steering movement amplitude takes place until the frictional connection potential has been exhausted.

8. Testing method according to claim 6,
wherein a steering mechanism is used for steering excitation.

9. Testing method according to claim 8,
wherein an increase of the steering movement amplitude takes place until the frictional connection potential has been exhausted.
